(19) United States
(12) Patent Application Publication
(10) Pub. No.: US 2020/0014974 A1
(43) Pub. Date: Jan. 9, 2020

(54) REMOTE CONTROL EXTENDER MECHANISM FOR A SET TOP BOX

(71) Applicant: Avago Technologies General IP (Singapore) Pte. Ltd., Singapore (SG)

(72) Inventors: Manan Patel, San Diego, CA (US); Rajesh MAMIDWAR, San Diego, CA (US); Prashant Katre, San Diego, CA (US); David ERICKSON, Irvine, CA (US)

(73) Assignee: Avago Technologies General IP (Singapore) Pte. Ltd., Singapore (SG)

(21) Appl. No.: 16/460,768

(22) Filed: Jul. 2, 2019

Related U.S. Application Data
(60) Provisional application No. 62/693,486, filed on Jul. 3, 2018.

(51) Int. Cl. H04N 21/4363; H04N 21/436; H04N 21/4227; H04N 21/633

(52) U.S. Cl. CPC H04N 21/43635; H04N 21/633; H04N 21/4227; H04N 21/43615

(57) ABSTRACT

In some aspects, the disclosure is directed to methods and systems for controlling a set top box remotely and monitoring its display output. Remote control commands may be intercepted or captured and forwarded over a network as encapsulated serial data or HDMI-CEC, in some implementations. This data may be transmitted over a network to a processing device, sometimes referred to as an HDMI pass-through and streamer device. The HDMI pass-through device may receive the encapsulated serial data via the network and retransmit the data as CEC data over HDMI to the set top box as if it were any other HDMI capable device, such as a television. Thus, the recipient set top box may receive the remote control commands via CEC and treat them as incoming IR commands and act accordingly.

### RELATED APPLICATIONS

The present application claims the benefit of and priority to U.S. Provisional Patent Application No. 62/693,486, entitled “Remote Control Extender Mechanism for a Set Top Box,” filed Jul. 3, 2018, the entirety of which is incorporated by reference herein.

### FIELD OF THE DISCLOSURE

This disclosure generally relates to systems and methods for remote multimedia presentation and control. In particular, this disclosure relates to systems and methods for extending remote controls and multimedia over a network and High-Definition Multimedia Interfaces (HDMI).

### BACKGROUND OF THE DISCLOSURE

Set top boxes are frequently used for tuning and decoding cable broadcast streams, as well as recording and playing back multimedia. In typical setups, these set top boxes are deployed in connection with a display, such as a television or projector. A viewer may operate a wireless remote control (e.g. using Bluetooth, Infrared, or other such interface) to control the set top box to tune to broadcast channels, play recorded multimedia content, control volume settings, or otherwise interact with the set top box (and, in many implementations, the television or other display). The devices must typically be in the same room, limiting flexibility of use.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an implementation of a set top box, display, and remote control;

FIG. 2 is a block diagram of an implementation of extension of remote control of a set top box, display over a network and HDMI;

FIG. 3 is a block diagram of an implementation of remote control extension for a set top box and display over a local area network and HDMI, such as within a house;

FIG. 4 is a block diagram of an implementation of a set top box, display, and remote control extension over a network between a remote site and a local site;

FIG. 5 is a block diagram of an implementation of a set top box configured for remote control extension;

FIG. 6 is a flow chart of an implementation of a method for remote control of media sources;

FIG. 7A is a block diagram depicting an embodiment of a network environment including one or more access points in communication with one or more devices or stations; and

FIGS. 7B and 7C are block diagrams depicting embodiments of computing devices useful in connection with the methods and systems described herein.

The details of various embodiments of the methods and systems are set forth in the accompanying drawings and the description below.

### DETAILED DESCRIPTION

The following IEEE standard(s), including any draft versions of such standard(s), are hereby incorporated herein by reference in their entirety d are made part of the present disclosure for all purposes: IEEE P802.11n™; and IEEE P802.11ac™. Although this disclosure may reference aspects of these standard(s), the disclosure is in no way limited by these standard(s).

For purposes of reading the description of the various embodiments below, the following descriptions of the sections of the specification and their respective contents may be helpful:
Section A describes embodiments of systems and methods for a remote control extender mechanism for a set top box; and
Section B describes a network environment and computing environment which may be useful for practicing embodiments described herein.

### A. Remote Control Extender Mechanism for a Set Top Box

Set top boxes are frequently used for tuning and decoding cable broadcast streams, as well as recording and playing back multimedia. In typical setups, these set top boxes are deployed in connection with a display, such as a television or projector. A viewer may operate a wireless remote control (e.g. using Bluetooth, Infrared, or other such interface) to control the set top box to tune to broadcast channels, play recorded multimedia content, control volume settings, or otherwise interact with the set top box. In many implementations, the remote control may also control functions of the television or other display. For example, in many implementations, the display may connect to the set top box via a digital interface such as the High-Definition Multimedia Interface (HDMI) interface. These interfaces may allow for transmission of additional data, e.g. serial data such as remote control data. One such implementation utilizes a Consumer Electronics Control (CEC) protocol or AV.link protocol.

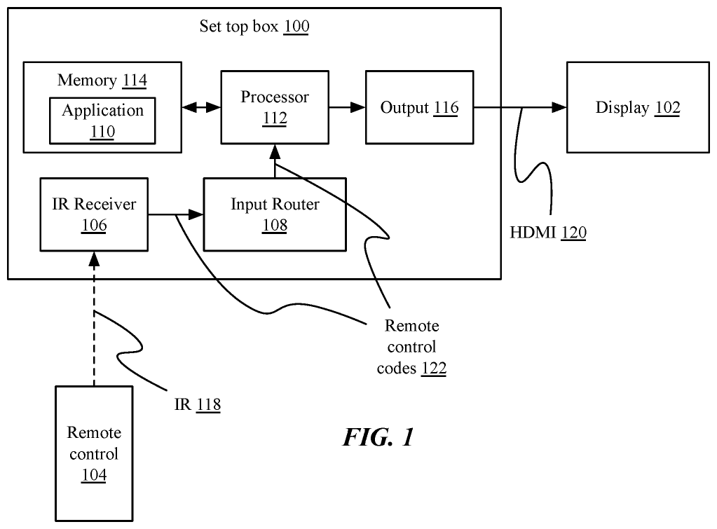

For example, referring first to FIG. 1, illustrated is a block diagram of an implementation of a set top box, display, and remote control environment. As shown, a set top box 100 may communicate with a display 102 via an HDMI signal 120 to provide a multimedia stream (e.g. video and/or audio). A remote control 104 may communicate with the set top box 100 via an infrared (IR) signal 118 in many implementations. The IR signal 118 may be received by an IR receiver 106 of the set top box 100 and converted into a serial data signal comprising remote control codes 122. The remote control codes 122 may be received by an input router 108 in some implementations, and/or provided to a processor 112 of the set top box. In many implementations, the processor 112 may execute a software application 110 stored in a memory device 114 of the set top box 100, which may perform playback of multimedia, provide an interactive menu, control multimedia decoders, etc. The multimedia output and/or rendered menus or other interactive content may be provided via HDMI signal 120 to display 102. As discussed above, display 102 may comprise a television, monitor, projector, touch screen display, or other such visual display, and/or may comprise additional components not illustrated such as audio/video receivers, tuners, processors, 3D processors, 3D displays, or other such devices.

As discussed above, devices 100, 102, 104 must typically be in the same room, limiting flexibility of use. However, in implementations of the systems and methods discussed herein, remote control signals 122 may be extended over a network, along with display signals (e.g. HDMI signal 120) in many implementations. This may allow for distribution of a set top box and displays in different rooms of a building or residence, as well as extension over a larger network (e.g. a Wide Area Network or WAN, such as the Internet). This may allow both for consumer uses (e.g. having a display in one room of a house with a set top box in another), as well as professional uses (e.g. having an engineer working remotely on a set top box at a remote site over the Internet).

To control a set top box remotely and monitor its display output, in some implementations, remote control commands may be intercepted or captured and forwarded over a network as encapsulated serial data or HDMI-CEC, in some implementations. This data may be transmitted over a local area network or LAN, a WAN, or a combination of local and wide area networks, to a processing device, sometimes referred to as an HDMI pass-through and streamer device. The HDMI pass-through device may receive the encapsulated serial data via the network and retransmit the data as CEC data over HDMI to the set top box as if it were any other HDMI capable device, such as a television. Thus, the recipient set top box may receive the remote control commands via CEC and treat them as incoming IR commands and act accordingly. In some implementations, the HDMI CEC channel, encapsulated for transmission over a network, may also carry other data instead of or in addition to remote control data: e.g., diagnostic information, configuration details, or any other type and form of transmission.

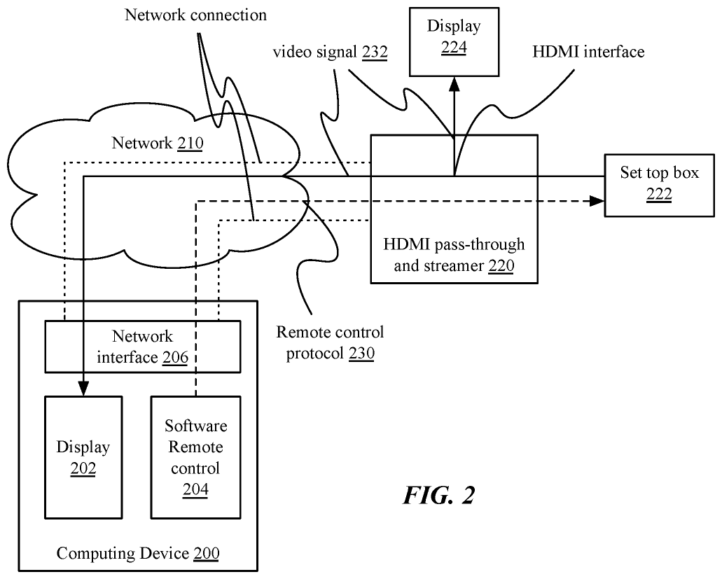

FIG. 2 is a block diagram of an implementation of extension of a set top box, display, and remote control over a network. In some implementations, a computing device 200 may take the place of a remote control. For example, a software remote control 204 may comprise an application, server, service, daemon, routine, or other executable logic for sending CEC-compatible remote control commands (or a similar remote control protocol 230) via a network. The software remote control 204 may generate serial data, for example, similar to the data output by an IR receiver as discussed above. The software remote control 204 may encapsulate the serial data for transmission via a network, e.g. via a transport and/or internet layer protocol, such as the transport layer protocol (TCP) or user datagram protocol (UDP) over an Internet Protocol (e.g. IPv4, IPv6, etc.), or any other lossy or lossless protocol or protocols. In many implementations, remote control commands may be considered lossy, in that no acknowledgement response is expected from a transmission (for example, an IR remote control does not expect and may not be able to receive an acknowledgement response from a set top box or television; accordingly, encapsulating and transmitting such commands via a lossy protocol such as UDP may be sufficient). A network interface 206 may comprise an Ethernet interface, 802.11 (WiFi) interface, cellular interface, or any other type and form of network interface, and may comprise a network stack and/or drivers for encapsulating an application layer or session layer transmission via a transport layer and/or internet layer protocol (e.g. TCP/IP or UDP/IP). Computing device 200 may also comprise or interact with a display 202, such as a monitor, television, projector, or other such interface.

The remote control protocol signal 230 may be transmitted via a network 210, which may comprise any type and form of network or networks, such as a LAN, a WAN, a metropolitan area network (MAN), a satellite network, a cellular network, a broadband cable network, a fiber optic network, a mesh network, or other network. Network 210 may comprise one or more additional devices not illustrated, such as switches, routers, network address translators, load balancers, accelerators, gateways, or other such devices.

The remote control protocol signal 230 may be provided to a pass-through and streamer device 220, which may comprise a network interface for communicating with network 210 to receive remote control protocol signals and/or provide video signals 232 such as HDMI signals for output to a display 202. The pass-through and streamer device 220 may also include outputs to a set top box 222, e.g. via HDMI. The pass-through and streamer device 220 may decapsulate or extract a remote control protocol command (e.g. CEC or other serial data) from one or more network packets (e.g. decapsulating UDP/IP packets to recover the remote control serial data) and may retransmit the remote control commands via HDMI-CEC or a similar interface to set top box 222. Thus, a remote control such as that provided by remote control software 204 on computing device 200 or another remote control may provide remote control commands to a set top box 222 over a network 210 without modification of the set top box 222.

Similarly, set top box 222 may output one or more HDMI streams (e.g. video and/or audio). The HDMI stream may be received by pass-through and streamer device 220 and retransmitted to a local display 224 in some implementations (e.g. via an HDMI interface as shown), and/or via network 210 to a remote display 202 of a computing device 200 and/or a local display or television (not illustrated). The streamer device 220 may thus serve as a local repeater and/or remote transmitter of the HDMI signal. In some implementations, streamer device 220 may encapsulate an HDMI stream via a transport and/or Internet layer protocol such as UDP/IP or other protocol. In some implementations, streamer device 220 may comprise a multimedia server, such as a hypertext transfer protocol (HTTP) live streaming (HLS) protocol streaming server or similar streaming server for packetizing, encapsulating, and transmitting multimedia data received by the streamer device 220 such as an input HDMI signal. Accordingly, as shown, the video signal 232 and remote control protocol 230 may be transmitted via a network connection over network 210 (e.g. Ethernet, WiFi, cellular, etc.).

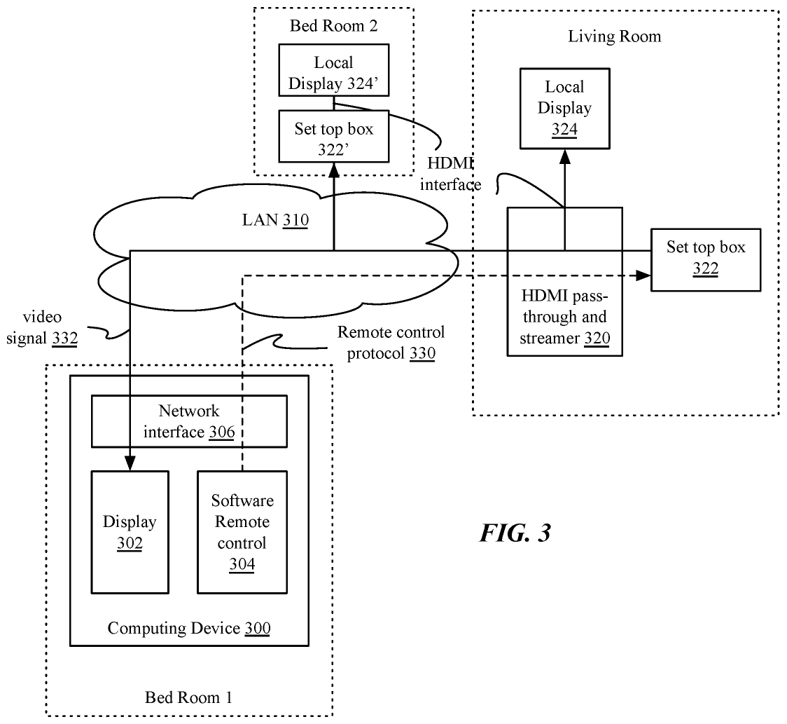

FIG. 3 is a block diagram of another implementation of extension of a set top box, display, and remote control over a local area network, such as within a house. For example, as shown, a computing device 300 in a first bedroom, comprising a display 302, remote control 304, and network interface 306 may communicate via a local network 310 (and over a network connection such as an Ethernet cable or WiFi connection, not illustrated) to a set top box 322 in a living room via an HDMI pass-through and streamer device 320. The video signal output 332 from the set top box 322 may be provided to a local display 324 in the living room (e.g. via HDMI), to another display 324′ (e.g. television, projector, etc.) in a second room such as a second bed room via a second set top box 322′, the display 302 of the computing device 300 in the the first bedroom, and/or another computing device 300′ (not illustrated). Thus, a single set top box 322 may be used to provide decoding of multimedia (e.g. broadcast video and/or audio) to multiple displays or other output devices throughout a home.

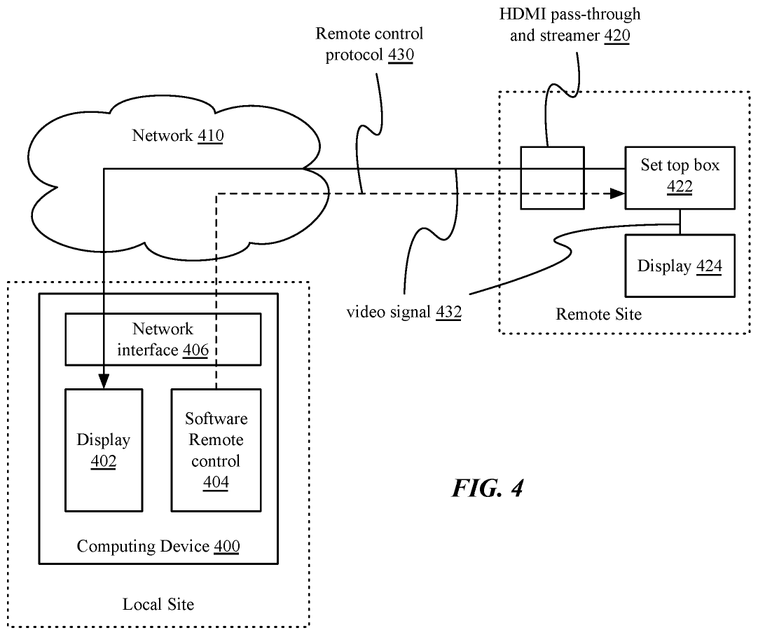

As discussed above, the network may comprise a wide area network between multiple locations, such as the Internet. Thus, the pass-through and streamer device may provide for remote viewing and control of a set top box. FIG. 4 is a block diagram of an implementation of a set top box, display, and remote control over a network between a remote site and a local site. As shown, a computing device 400, comprising a display 402, remote control 404, and network interface 406 may communicate via a network 410 to send remote control commands 430 to an HDMI source 422 such as a set top box, via an HDMI pass-through and streamer device 420; and may receive a video signal 432 over the network (via a network connection, not illustrated) for display by display 402. Although discussed above primarily in terms of a set top box and decoding of broadcast signals, any HDMI signal may be retransmitted via the network. Thus, the HDMI pass-through and streamer device 420 may provide any HDMI output, including an HDMI signal from a desktop computer, laptop computer, workstation, or other computing device. Accordingly, the HDMI pass-through and streamer device 420 may provide remote desktop viewing functionality. In some implementations, the set top box or other media source 422 may also provide a local output to a local display 424, e.g. a monitor or television.

In some implementations, to enable connection over a network, the HDMI CEC channel or similar channel may be used for sharing additional information, such as an IP address or other configuration information between two set top boxes or other devices. Such implementations may enable a first set top box to identify an IP address of another set top box connected only via HDMI (rather than being attached to the same LAN or WAN). The first set top box may then stream content to the second via this IP address, and/or may receive streamed content from the second set top box.

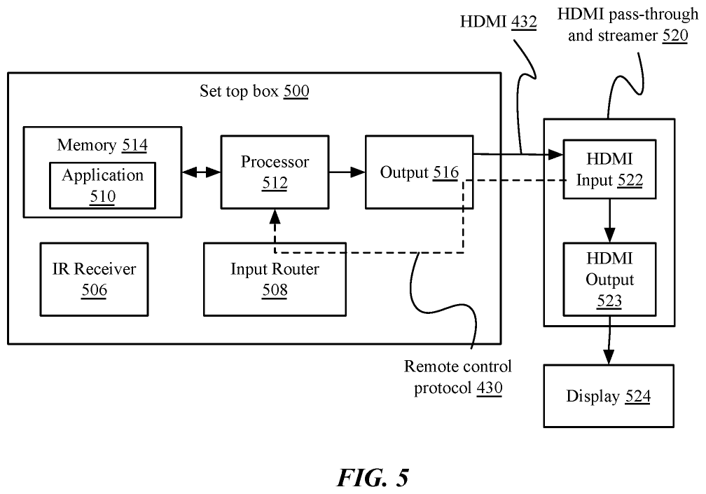

FIG. 5 is a block diagram of an implementation of a set top box configured for remote control extension over a network. An HDMI pass-through and streamer device 520 may be connected to a set top box 500 via an HDMI interface 432 or similar interface (e.g. from an output interface 516 to an input interface 522). A return channel such as HDMI CEC may be provided via the same interface (e.g. from input interface 522 “in reverse” to output interface 516). A remote control protocol signal 430, such as serial data, may be provided over the return channel to an input router 508. Input router 508 may receive remote control signals, either from an IR receiver 506 from a locally received IR signal from a remote control, or via the HDMI CEC return channel or similar return channel. The input router 508 may provide the remote control signal from whichever source to the processor 512 for processing via application 510 stored in memory device 514. In some implementations, HDMI pass-through and streamer device 520 may also include an HDMI output interface 523 for connection (e.g. via HDMI) to a display 524 (e.g. television).

Thus, commands received via HDMI CEC or a similar return channel may be considered equivalent to IR commands, with conversion provided in hardware and/or software of the input router 508 and/or processor 512. Commands transmitted and/or received via a network interface may be similarly converted to serial data and processed similarly to a command received via an IR receiver 506. As discussed above, such commands may be provided over a network, with CEC or IR serial data encapsulated and packetized for transmission via the network. The streaming device may similarly send video from an HDMI input or other media input over a network, performing any encoding, encapsulation, and/or packetization necessary, including generation of streaming manifests or other metadata.

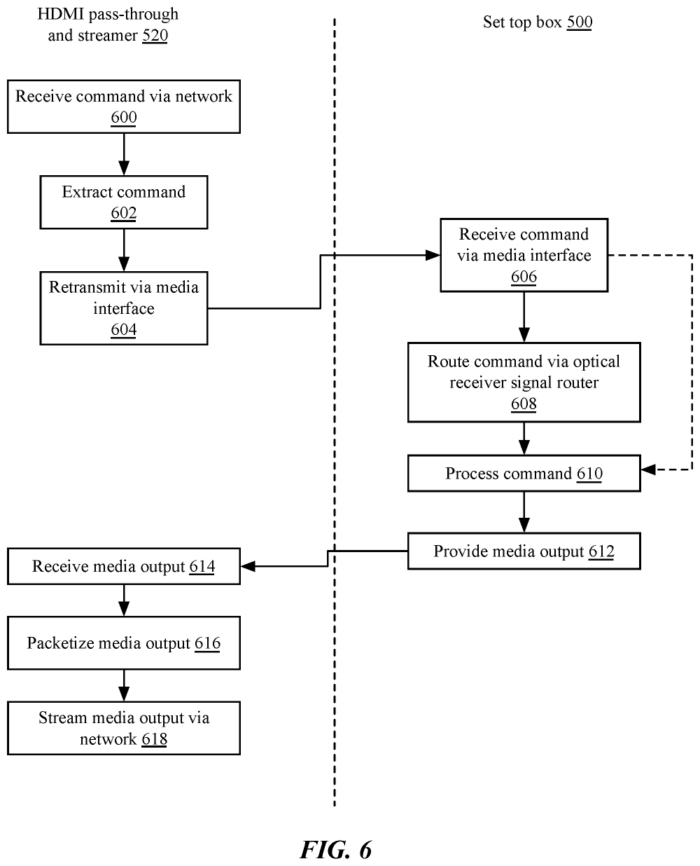

FIG. 6 is a flow chart of an implementation of a method for remote control of media sources. At step 600, a pass-through and streamer device may receive a remote control command via a network interface from a remote device. The network interface may comprise a communications interface to a local area network or wide area network, such as the Internet, including an Ethernet interface, a WiFi interface, a broadband interface, or any other type and form of network interface. Receiving the remote control command may comprise performing a handshaking routine or otherwise establishing a connection with the remote device, such as performing authentication or login processes. The remote control command may comprise a packetized serial command with transport and network layer headers added by the remote device. The serial command may be a remote control serial command in a format utilized or generated in response to a received signal by an optical receiver of a set top box, such as an IR receiver.

At step 602, the pass-through and streamer device may extract the remote control command from the received command. Extracting the remote control command may comprise decapsulating serial data of one or more network packets. In some implementations, extracting the remote control command may comprise performing defragmentation actions on a plurality of packet fragments, performing decompression and/or decryption, or otherwise processing the network packet or packets. The serial data may be encapsulated as a payload of the packet (e.g. at an application layer of the packet, in some implementations). In other implementations, the serial data may be extracted from any other portion of the packet, such as an options field of a transport or network layer header.

At step 604, the pass-through and streamer device may retransmit the extracted remote control command to a second device, such as a set top box or smart television, sometimes referred to as a media sink or receiver, via a media interface. Retransmitting the extracted remote control command may comprise providing serial data of the remote control command via an HDMI CEC channel or similar control channel of a media interface, such as an HDMI interface. Retransmitting the extracted remote control command may thus comprise encoding or reformatting serial data of the command into a format compatible with the return channel (e.g. for example, encoding serial binary data of an IR remote control signal via transition minimized differential signaling (TMDS), 8b/10b encoding, or any other encoding scheme utilized by the return channel of the media interface).

At step 606, the second device may receive the command via the media interface. In some implementations, at step 608, the second device may provide the command to an input router of the second device. The input router may be configured to selectively route signals from an input interface, such as an optical or IR interface, or from the media interface. By routing the command to a processor of the device via the input router, the processor may be unaware or agnostic to whether the command was received via the input interface or via the media interface. This may be particularly beneficial in testing commands received via the input interface remotely, e.g. from an administrator or user's device communicating via a network and the pass-through and streamer device. In such implementations, serial data of the command may be in a format utilized by the input interface, e.g. a binary serial command string. In other implementations, the second device may be able to directly extract and process the command (skipping step 608).

At step 610, a processor of the second device may process the command. Processing the command may comprise modifying one or more parameters of the device, such as changing a decoder channel or tuning channel, modifying an output resolution of the device, or performing any other such functions.

In some implementations, at step 612, the second device may output media according to the reconfigured parameters. The media may be received via an external interface such as a broadband or cable interface, satellite interface, or other network source; a media source such as a DVD or other media player, a video game console, or other computing device; or an internal source such as a storage device (e.g. for video-on-demand playback). In some implementations, the media may be decoded, depacketized, and/or decompressed, and may be provided via a media interface to the pass-through and streamer device, such as via an HDMI interface.

At step 614, the pass-through and streamer device may receive the output media. In some implementations, at step 616, the pass-through and streamer device may packetize the output media, and at step 618, may stream the packetized media via the network to the remote device. Packetizing the output media may comprise encoding the output media into a suitable format for transmission via a packet-based network, compressing the output media, encrypting the output media, or performing other such functions on the output media. The media may be streamed to the remote device for display, such that a remote user of the remote device may provide remote control commands via the pass-through and streamer device to the second device, and may receive a generated output from the second device via the pass-through and streamer device.

By providing media outputs to an entire household from a single set top box, users may easily monitor channel changing commands on other devices or displays, allowing users to monitor and maintain multiple displays (e.g. allowing parents to monitor their children's media consumption in other rooms, for example).

Accordingly, to control a set top box remotely and monitor its display output, in some implementations, remote control commands may be intercepted or captured and forwarded over a network as encapsulated serial data or HDMI-CEC, in some implementations. This data may be transmitted over a local area network or LAN, a WAN, or a combination of local and wide area networks, to a processing device, sometimes referred to as an HDMI pass-through and streamer device. The HDMI pass-through device may receive the encapsulated serial data via the network and retransmit the data as CEC data over HDMI to the set top box as if it were any other HDMI capable device, such as a television. Thus, the recipient set top box may receive the remote control commands via CEC and treat them as incoming IR commands and act accordingly. In some implementations, the HDMI CEC channel, encapsulated for transmission over a network, may also carry other data instead of or in addition to remote control data: e.g., diagnostic information, configuration details, or any other type and form of transmission.

### B. Computing and Network Environment

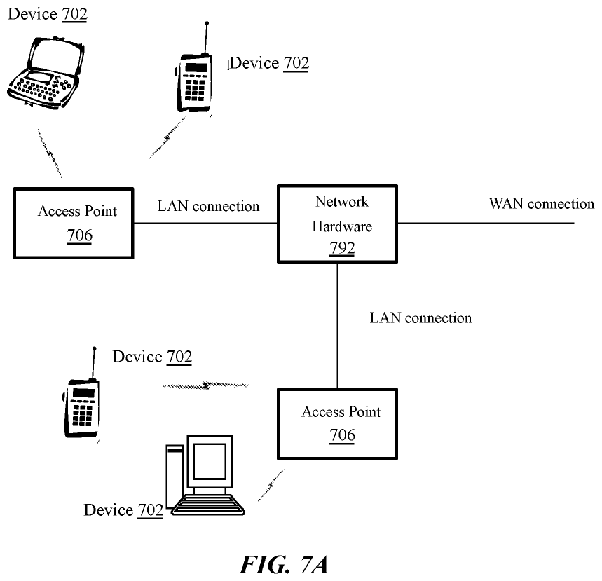

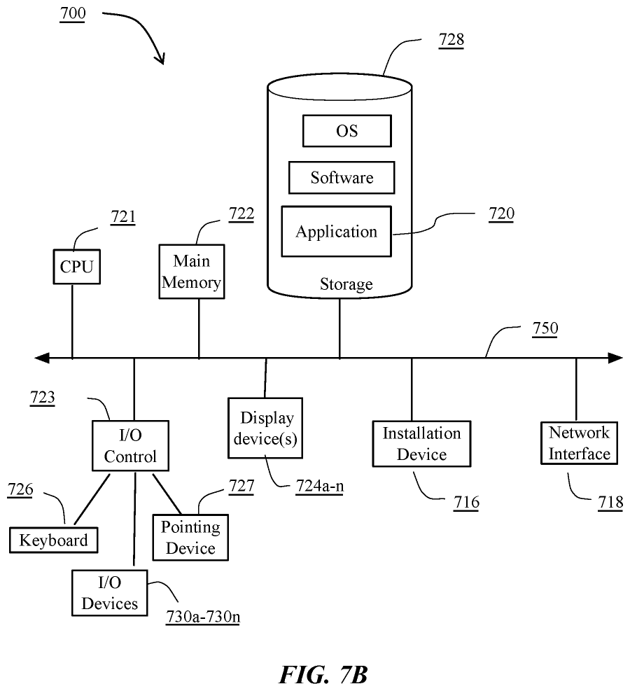

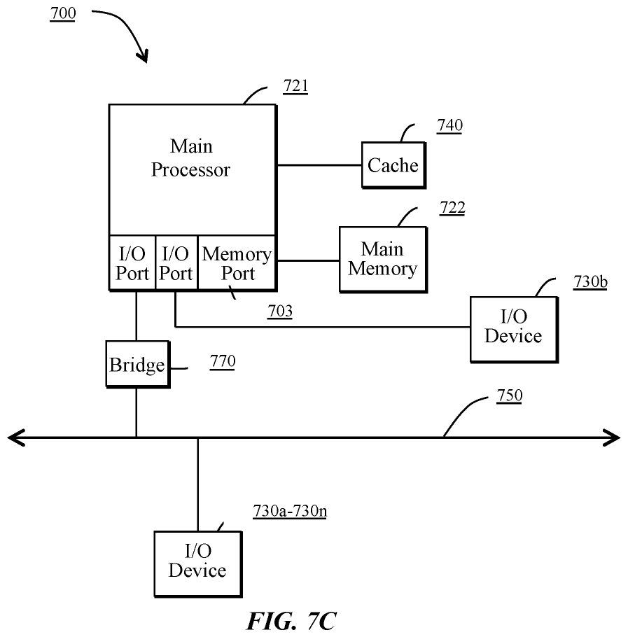

Having discussed specific embodiments of the present solution, it may be helpful to describe aspects of the operating environment as well as associated system components (e.g., hardware elements) in connection with the methods and systems described herein. Referring to FIG. 7A, an embodiment of a network environment is depicted. In brief overview, the network environment includes a wireless communication system that includes one or more access points 706, one or more wireless communication devices 702 and a network hardware component 792. The wireless communication devices 702 may for example include laptop computers 702, tablets 702, personal computers 702 and/or cellular telephone devices 702. The details of an embodiment of each wireless communication device and/or access point are described in greater detail with reference to FIGS. 7B and 7C. The network environment can be an ad hoc network environment, an infrastructure wireless network environment, a subnet environment, etc. in one embodiment

The access points (APs) 706 may be operably coupled to the network hardware 792 via local area network connections. The network hardware 792, which may include a router, gateway, switch, bridge, modem, system controller, appliance, etc., may provide a local area network connection for the communication system. Each of the access points 706 may have an associated antenna or an antenna array to communicate with the wireless communication devices 702 in its area. The wireless communication devices 702 may register with a particular access point 706 to receive services from the communication system (e.g., via a SU-MIMO or MU-MIMO configuration). For direct connections (e.g., point-to-point communications), some wireless communication devices 702 may communicate directly via an allocated channel and communications protocol. Some of the wireless communication devices 702 may be mobile or relatively static with respect to the access point 706.

In some embodiments an access point 706 includes a device or module (including a combination of hardware and software) that allows wireless communication devices 702 to connect to a wired network using Wi-Fi, or other standards. An access point 706 may sometimes be referred to as an wireless access point (WAP). An access point 706 may be configured, designed and/or built for operating in a wireless local area network (WLAN). An access point 706 may connect to a router (e.g., via a wired network) as a standalone device in some embodiments. In other embodiments, an access point can be a component of a router. An access point 706 can provide multiple devices 702 access to a network. An access point 706 may, for example, connect to a wired Ethernet connection and provide wireless connections using radio frequency links for other devices 702 to utilize that wired connection. An access point 706 may be built and/or configured to support a standard for sending and receiving data using one or more radio frequencies. Those standards, and the frequencies they use may be defined by the IEEE (e.g., IEEE 802.11 standards). An access point may be configured and/or used to support public Internet hotspots, and/or on an internal network to extend the network's Wi-Fi signal range.

In some embodiments, the access points 706 may be used for (e.g., in-home or in-building) wireless networks (e.g., IEEE 802.11, Bluetooth, ZigBee, any other type of radio frequency based network protocol and/or variations thereof). Each of the wireless communication devices 702 may include a built-in radio and/or is coupled to a radio. Such wireless communication devices 702 and/or access points 706 may operate in accordance with the various aspects of the disclosure as presented herein to enhance performance, reduce costs and/or size, and/or enhance broadband applications. Each wireless communication devices 702 may have the capacity to function as a client node seeking access to resources (e.g., data, and connection to networked nodes such as servers) via one or more access points 706.

The network connections may include any type and/or form of network and may include any of the following: a point-to-point network, a broadcast network, a telecommunications network, a data communication network, a computer network. The topology of the network may be a bus, star, or ring network topology. The network may be of any such network topology as known to those ordinarily skilled in the art capable of supporting the operations described herein. In some embodiments, different types of data may be transmitted via different protocols. In other embodiments, the same types of data may be transmitted via different protocols.

The communications device(s) 702 and access point(s) 706 may be deployed as and/or executed on any type and form of computing device, such as a computer, network device or appliance capable of communicating on any type and form of network and performing the operations described herein. FIGS. 7B and 7C depict block diagrams of a computing device 700 useful for practicing an embodiment of the wireless communication devices 702 or the access point 706. As shown in FIGS. 7B and 7C, each computing device 700 includes a central processing unit 721, and a main memory unit 722. As shown in FIG. 7B, a computing device 700 may include a storage device 728, an installation device 716, a network interface 718, an I/O controller 723, display devices 724a-724n, a keyboard 726 and a pointing device 727, such as a mouse. The storage device 728 may include, without limitation, an operating system and/or software. As shown in FIG. 7C, each computing device 700 may also include additional optional elements, such as a memory port 703, a bridge 770, one or more input/output devices 730a-730n (generally referred to using reference numeral 730), and a cache memory 740 in communication with the central processing unit 721.

The central processing unit 721 is any logic circuitry that responds to and processes instructions fetched from the main memory unit 722. In many embodiments, the central processing unit 721 is provided by a microprocessor unit, such as: those manufactured by Intel Corporation of Mountain View, Calif.; those manufactured by International Business Machines of White Plains, N.Y.; or those manufactured by Advanced Micro Devices of Sunnyvale, Calif. The computing device 700 may be based on any of these processors, or any other processor capable of operating as described herein.

Main memory unit 722 may be one or more memory chips capable of storing data and allowing any storage location to be directly accessed by the microprocessor 721, such as any type or variant of Static random access memory (SRAM), Dynamic random access memory (DRAM), Ferroelectric RAM (FRAM), NAND Flash, NOR Flash and Solid State Drives (SSD). The main memory 722 may be based on any of the above described memory chips, or any other available memory chips capable of operating as described herein. In the embodiment shown in FIG. 7B, the processor 721 communicates with main memory 722 via a system bus 750 (described in more detail below). FIG. 7C depicts an embodiment of a computing device 700 in which the processor communicates directly with main memory 722 via a memory port 703. For example, in FIG. 7C the main memory 722 may be DRDRAM.

FIG. 7C depicts an embodiment in which the main processor 721 communicates directly with cache memory 740 via a secondary bus, sometimes referred to as a backside bus. In other embodiments, the main processor 721 communicates with cache memory 740 using the system bus 750. Cache memory 740 typically has a faster response time than main memory 722 and is provided by, for example, SRAM, BSRAM, or EDRAM. In the embodiment shown in FIG. 7C, the processor 721 communicates with various I/O devices 730 via a local system bus 750. Various buses may be used to connect the central processing unit 721 to any of the I/O devices 730, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 724, the processor 721 may use an Advanced Graphics Port (AGP) to communicate with the display 724. FIG. 7C depicts an embodiment of a computer 700 in which the main processor 721 may communicate directly with I/O device 730b, for example via HYPERTRANSPORT, RAPIDIO, or INFINIBAND communications technology. FIG. 7C also depicts an embodiment in which local busses and direct communication are mixed: the processor 721 communicates with I/O device 730a using a local interconnect bus while communicating with I/O device 730b directly.

A wide variety of I/O devices 730a-730n may be present in the computing device 700. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 723 as shown in FIG. 7B. The I/O controller may control one or more I/O devices such as a keyboard 726 and a pointing device 727, e.g., a mouse or optical pen. Furthermore, an I/O device may also provide storage and/or an installation medium 716 for the computing device 700. In still other embodiments, the computing device 700 may provide USB connections (not shown) to receive handheld USB storage devices such as the USB Flash Drive line of devices manufactured by Twintech Industry, Inc. of Los Alamitos, Calif.

Referring again to FIG. 7B, the computing device 700 may support any suitable installation device 716, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 700 may further include a storage device, such as one or more hard disk drives or redundant arrays of independent disks, for storing an operating system and other related software, and for storing application software programs such as any program or software 720 for implementing (e.g., configured and/or designed for) the systems and methods described herein. Optionally, any of the installation devices 716 could also be used as the storage device. Additionally, the operating system and the software can be run from a bootable medium.

Furthermore, the computing device 700 may include a network interface 718 to interface to the network 704 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 700 communicates with other computing devices 700′ via any type and/or form of gateway or tunneling protocol such as Secure Socket Layer (SSL) or Transport Layer Security (TLS). The network interface 718 may include a built-in network adapter, network interface card, PCMCIA network card, card bus network adapter, wireless network adapter, USB network adapter, modem or any other device suitable for interfacing the computing device 700 to any type of network capable of communication and performing the operations described herein.

In some embodiments, the computing device 700 may include or be connected to one or more display devices 724a-724n. As such, any of the I/O devices 730a-730n and/or the I/O controller 723 may include any type and/or form of suitable hardware, software, or combination of hardware and software to support, enable or provide for the connection and use of the display device(s) 724a-724n by the computing device 700. For example, the computing device 700 may include any type and/or form of video adapter, video card, driver, and/or library to interface, communicate, connect or otherwise use the display device(s) 724a-724n. In one embodiment, a video adapter may include multiple connectors to interface to the display device(s) 724a-724n. In other embodiments, the computing device 700 may include multiple video adapters, with each video adapter connected to the display device(s) 724a-724n. In some embodiments, any portion of the operating system of the computing device 700 may be configured for using multiple displays 724a-724n. One ordinarily skilled in the art will recognize and appreciate the various ways and embodiments that a computing device 700 may be configured to have one or more display devices 724a-724n.

In further embodiments, an I/O device 730 may be a bridge between the system bus 750 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 700 of the sort depicted in FIGS. 7B and 7C may operate under the control of an operating system, which control scheduling of tasks and access to system resources. The computing device 700 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Wash.; MAC OS, produced by Apple Computer of Cupertino, Calif.; WebOS, produced by Research In Motion (RIM); OS/2, produced by International Business Machines of Armonk, N.Y.; and Linux, a freely-available operating system distributed by Caldera Corp. of Salt Lake City, Utah, or any type and/or form of a Unix operating system, among others.

The computer system 700 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 700 has sufficient processor power and memory capacity to perform the operations described herein.

In some embodiments, the computing device 700 may have different processors, operating systems, and input devices consistent with the device. For example, in one embodiment, the computing device 700 is a smart phone, mobile device, tablet or personal digital assistant. In still other embodiments, the computing device 700 is an Android-based mobile device, an iPhone smart phone manufactured by Apple Computer of Cupertino, Calif., or a Blackberry or WebOS-based handheld device or smart phone, such as the devices manufactured by Research In Motion Limited. Moreover, the computing device 700 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users”, such “users” may refer to user-associated devices or stations (STAs), for example, consistent with the terms “user” and “multi-user” typically used in the context of a multi-user multiple-input and multiple-output (MU-MIMO) environment.

Although examples of communications systems described above may include devices and APs operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A method for remote control of media sources, comprising:
receiving, by a pass-through and streaming device via a network from a first device, an encapsulated remote control command for a second device;
extracting, by the pass-through and streaming device, the remote control command;
retransmitting, by the pass-through and streaming device, the remote control command via a return channel of a media interface, the second device receiving the remote control command and reconfiguring a media output of the second device according to the remote control command;
receiving, by the pass-through and streaming device from the second device the reconfigured media output; and
streaming, by the pass-through and streaming device, the reconfigured media output to the first device.

2. The method of claim 1, wherein receiving the encapsulated remote control command further comprises receiving serial data encapsulated in a transport layer protocol.

3. The method of claim 2, wherein receiving the encapsulated remote control command further comprises receiving a consumer electronics control (CEC) command, encapsulated in the transport layer protocol.

4. The method of claim 1, wherein extracting the remote control command further comprises removing transport and/or network layer headers from the encapsulated remote control command.

5. The method of claim 1, wherein retransmitting the remote control command further comprises transmitting a serial data string via the return channel of the media interface.

6. The method of claim 1, further comprising receiving, by the pass-through and streaming device from the second device via the media interface, a network address of the second device.

7. The method of claim 6, further comprising transmitting, by the pass-through and streaming device, the network address of the second device to the first device via the network.

8. The method of claim 7, wherein transmission of the network address of the second device to the first device causes the first device to transmit, to the second device via a second network, media content.

9. A system for remote control of media sources, comprising:
a pass-through and streaming device comprising a first communication circuit in communication with a first device via a network, a second communication circuit in communication with a second device via a media interface, and a processor circuit configured to:
receive, via the first communication circuit from the first device, an encapsulated remote control command for a second device;
extract the remote control command;
retransmit, via the second communication circuit, the remote control command via a return channel of the media interface, the second device receiving the remote control command and reconfiguring a media output of the second device according to the remote control command;
receive, via the second communication circuit from the second device, the reconfigured media output; and
stream, via the first communication circuit to the first device, the reconfigured media output.

10. The system of claim 9, wherein the processor circuit is further configured to receive the encapsulated remote control command as serial data encapsulated in a transport layer protocol.

11. The system of claim 10, wherein the processor circuit is further configured to receive the encapsulated remote control command as a consumer electronics control (CEC) command, encapsulated in the transport layer protocol.

12. The system of claim 8, wherein the processor circuit is further configured to remove transport and/or network layer headers from the encapsulated remote control command.

13. The system of claim 8, wherein the processor circuit is further configured to retransmit the remote control command as a serial data string via the return channel of the media interface.

14. The system of claim 8, wherein the processor circuit is further configured to receive, from the second device via the media interface, a network address of the second device.

15. The system of claim 14, wherein the processor circuit is further configured to transmit the network address of the second device to the first device via the network.

16. A method for remote control of media sources, comprising:
receiving, by a communications circuit of a set top box via a return channel of a media interface from a pass-through and streaming device, a remote control command;
providing, by the communications circuit, the remote control command to an input router of the set top box;
routing, by the input router, the remote control command received from the communications circuit to a processor of the set top box; and
reconfiguring, by the processor, a media output of the set top box according to the remote control command.

17. The method of claim 16, wherein the input router is in communication with an optical receiver of the set top box; and
wherein routing the remote control command comprises switching, by the input router, an input circuit of the input router from the optical receiver to the communications circuit.

18. The method of claim 17, further comprising:
receiving a second remote control command, via the optical receiver of the set top box; and
routing, by the input router, the second remote control command from the optical receiver to the processor of the set top box.

19. The method of claim 17, wherein the remote control command comprises a serial signal in a format of the optical receiver.

20. The method of claim 19, wherein the processor is agnostic as to whether the remote control command was received by the optical receiver or the communication circuit.
